(19) United States
(12) Patent Application Publication
(10) Pub. No.: US 2025/0079762 A1
(43) Pub. Date: Mar. 6, 2025

(54) LEVER LOCK ELECTRICAL CONNECTOR WITH ADDITIONAL LOCK

(71) Applicant: Aptiv Technologies (2) S.à r.l., Luxembourg (LU)

(72) Inventor: Kevin S. Turner, Vienna, OH (US)

(21) Appl. No.: 18/238,895

(22) Filed: Aug. 28, 2023

(51) Int. Cl. H01R 13/629; H01R 13/627

(52) U.S. Cl. CPC H01R 13/62955; H01R 13/6273; H01R 13/62938

(57) ABSTRACT

An electrical connector includes a first housing portion configured to receive a second housing portion in seated alignment to form a housing of the electrical connector. The connector further includes first lock on the first housing portion that includes a lever rotatable between an unlocked position where the second housing portion is removable from the first housing portion, and a locked position that secures the first and second housing portions in seated alignment. The connector further includes a connector position assurance (CPA) device that, in a staged position, engages with the first lock to maintain the lever in the locked position. The connector further includes a second lock that, in the staged position, further secures the first and second housing portions in seated alignment.

### BACKGROUND

Electrical connectors are commonly used in many commercial, industrial, and military applications to implement electrical power, signal, and data systems. In some applications, such as automotive or aerospace applications, it is desirable to provide electrical connectors that are relatively easy to install to support efficient manufacturing processes. It is also important in many applications that electrical connectors be resistant to unintentional decoupling during vehicle use, transport, maintenance, or during assembly processes. As such, a need exists for improved electrical connector designs that are relatively easy to install and offer improved decoupling resistance once they are installed.

### SUMMARY

An electrical connector is described. The connector includes a first housing portion configured to receive a second housing portion in seated alignment to form a housing of the electrical connector. The connector further includes first lock on the first housing portion that includes a lever rotatable between an unlocked position where the second housing portion is removable from the first housing portion, and a locked position that secures the first and second housing portions in seated alignment. The connector further includes a connector position assurance (CPA) device that, in a staged position, engages with the first lock to maintain the lever in the locked position. The connector further includes a second lock that, in the staged position, further secures the first and second housing portions in seated alignment. In some examples, the first lock engages the second housing portion to secure the first and second housing portions in seated alignment, and the second lock engages the first housing portion in the staged position to further secure the first and second housing portions in seated alignment. In some examples, the second lock engages a ledge of the first housing portion when the CPA is moved from a pre-staged position to the staged position.

According to other examples, a method is described. The method includes forming a first housing portion. The method further includes forming a second housing portion configured to be arranged in seated alignment with the first housing portion to form a housing of the electrical connector. The method further includes forming a first lock on the first housing portion that includes a lever rotatable between an unlocked position where the second housing portion is removable from the first housing portion, and a locked position that secures the first and second housing portions in seated alignment. The method further includes forming a connector position assurance (CPA) device configured to engage, in a staged position, with the first lock to maintain the lever in the locked position. The method further includes forming a second lock that, in the staged position further secures the first and second housing portions in seated alignment. In some examples, the method further includes forming the first lock to interface with the second housing portion in the locked position, and forming the second lock to interface with the first housing portion in the staged position. In some examples, the method further includes forming a ledge on the first housing portion. In some examples, the method further includes forming the second lock to interface with the ledge.

As another example, a connector position assurance (CPA) device is described. The CPA includes securing arms arranged to fit within a channel of a first lock of an electrical connector comprising a lever in a pre-staged position of the CPA, and define a staged position of the CPA. The CPA device further includes a tongue feature configured to, in the staged position, maintain the first lock in a locked position to secure a first housing portion and a second housing portion in seated alignment to form a housing of the electrical connector. The CPA device further includes a second lock that further secures the first and second housing portions in seated alignment. In some examples, the second lock interfaces with a first housing portion of the electrical connector to maintain the first lock in the locked position, and the first lock interfaces with a second housing portion in the locked position. In some examples, the second lock is configured to interface with a ledge presented by the first housing portion in the staged position.

### DESCRIPTION OF THE DRAWINGS

FIG. 1 is a diagram showing an electrical connector according to some embodiments.

FIG. 2 is a diagram showing an exploded view of an electrical connector according to some embodiments.

FIG. 3 is a diagram showing an electrical connector in an unlocked position according to some embodiments.

FIG. 4 is a diagram showing a perspective view of an electrical connector in a locked position according to some embodiments.

FIG. 5 is a diagram showing a connector position assurance (CPA) that includes a second lock according to some embodiments.

FIG. 6A is a diagram depicting a perspective view of one example of a CPA and a first housing portion in a pre-staged position according to some embodiments.

FIG. 6B is a diagram depicting a perspective view of one example of a CPA and a first housing portion in a staged position according to some embodiments.

FIG. 7A is a diagram depicting a cross-sectional view of an electrical connector with a CPA in a pre-staged position according to some embodiments.

FIG. 7B is a diagram depicting a cross-sectional view of an electrical connector with a CPA in a staged position according to some embodiments.

FIG. 8 is a diagram depicting a cross-sectional view of one example of a CPA and a first housing portion according to some embodiments.

FIG. 9 is a flow diagram depicting one example of a method of providing an electrical connector according to some embodiments.

### DETAILED DESCRIPTION

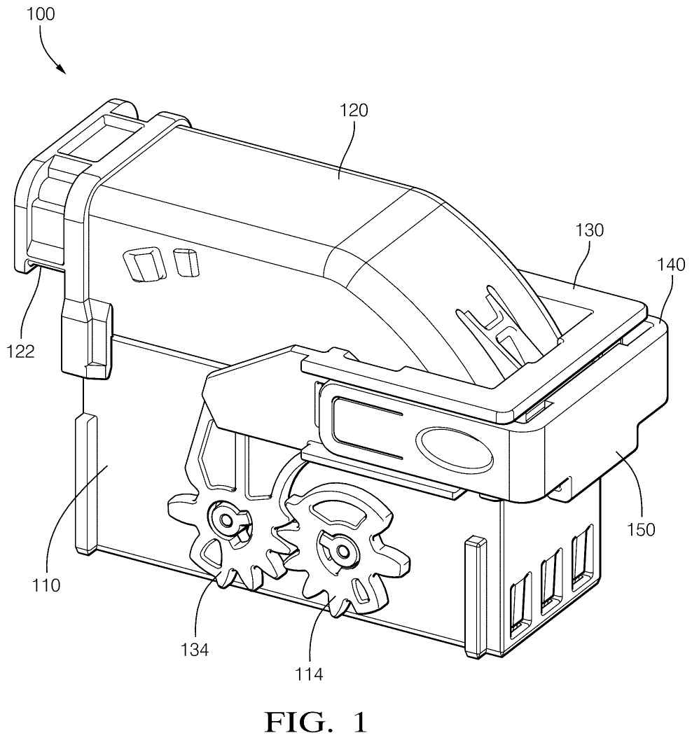

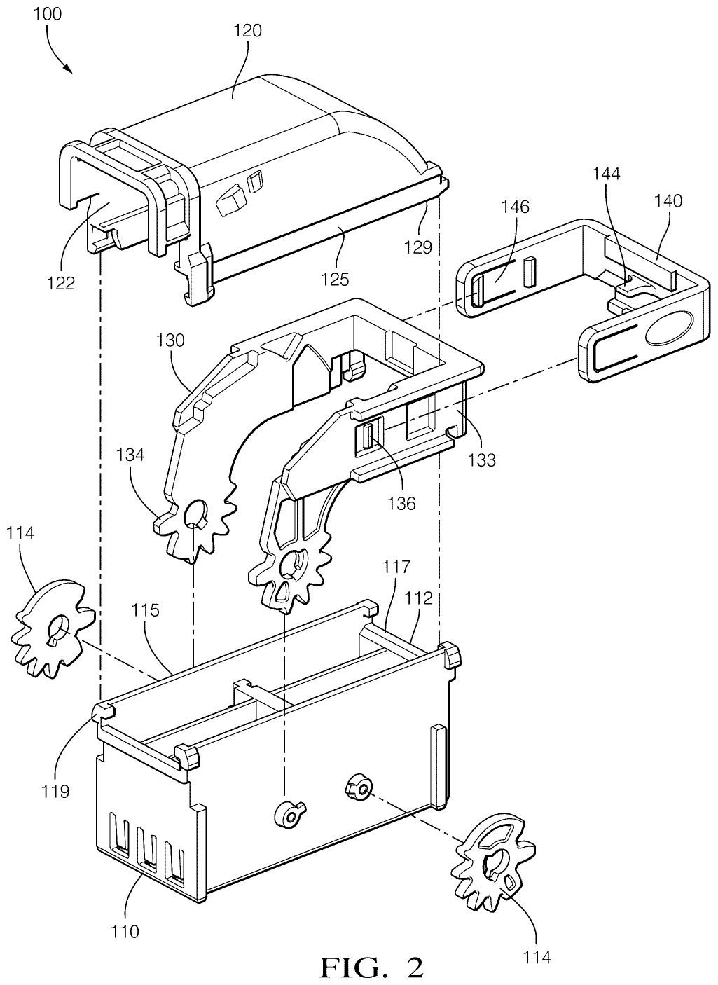

FIG. 1 is a diagram that shows one example of an electrical connector 100 according to some embodiments. In the example of FIG. 1, connector 100 is shown with first and second locks engaged. FIG. 2 is a diagram showing an exploded view of example components of an electrical connector 100 according to some embodiments.

Referring to the example of FIG. 1, electrical connector 100 is configured to support the coupling of electrical conductors as part of a larger electrical system, such as the electrical system of a vehicle. Electrical connector 100 is a lever lock connector that includes a housing that serves as an enclosure to secure electrical connections within the housing. In the example of FIG. 1, second housing 120, which may be referred to as a “wiring dress,” defines a header opening 122. Header opening 122 may carry electrical conductors, such as a wiring bundle, within second housing portion 120. The electrical conductors may terminate in a first terminal array arranged to interface with a corresponding second terminal array within the first housing portion 110 to form electrical connections housed within connector 100. For example, when the lever lock is engaged as shown in FIG. 1, the terminal arrays (not shown) may be brought together in mating alignment, thereby forming a plurality of electrical connections within the housing of connector 100. Connector 100 may thereby be used to establish, and protect, electrical connections between the electrical conductors that are used to distribute power, signal, and/or data as part of an electrical system of a vehicle.

In some examples, electrical connector 100 may be particularly well suited to enable efficient implementation in complex vehicle manufacturing processes. For example, connector 100 described herein may be particularly easy for an operator to secure in a locked position. At the same time, the described connector 100 may be highly resistant to unintended decoupling during further vehicle manufacturing processes, transportation, or use.

As shown in FIGS. 1-3, connector 100 includes a first housing portion 110 configured to receive a second housing portion 120 in seated alignment to form a housing of connector 100. First housing portion 110 and/or second housing portion 120 may include one or more features that enable an operator to reliably arrange the first and second housing portions 110 in seated alignment.

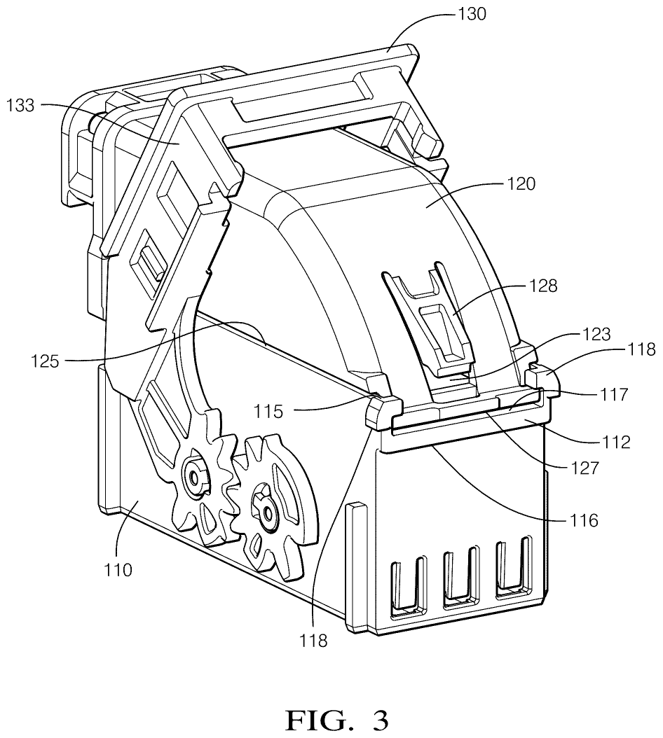

For example, as shown in FIG. 2, first housing portion 110 includes alignment features 119 configured to receive a ridge 129 presented on second housing portion 120, and an upper surface 115 configured interact with a corresponding surface 125 of second housing portion 120 in sliding engagement. As shown in FIG. 3, first housing portion 110 may further include stops 118, which serve to define a seated position of second housing portion 120 relative to first housing portion 110.

In operation as part of a vehicle manufacturing process, a human or machine operator may align ridge 127 of second housing portion 120 within features 119, and push second housing portion 120 along surface 115 of second housing portion 120 until it reaches stops 118, defining a seated position of the second housing portion 120 relative to the first housing portion 110.

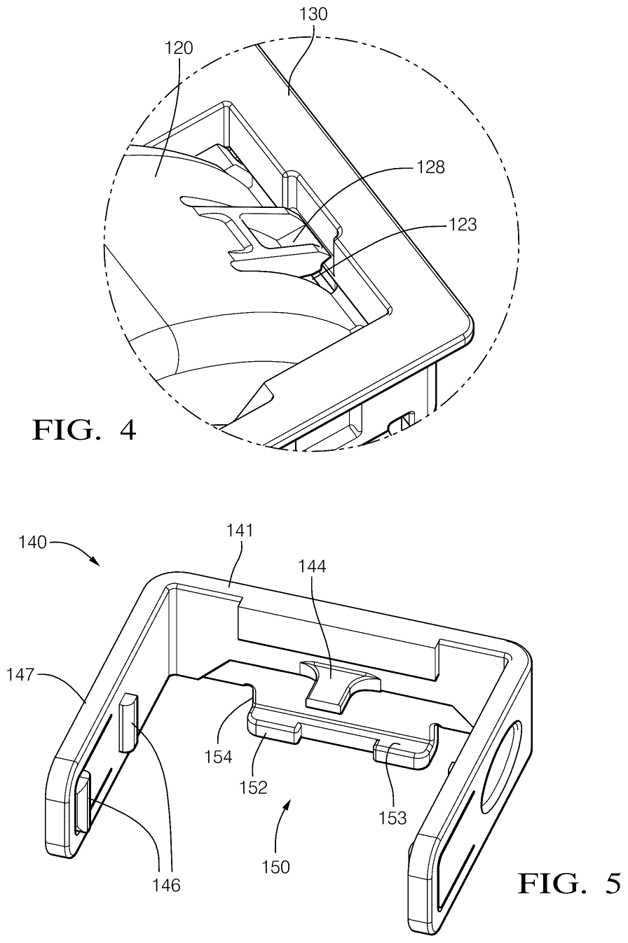

As also shown in FIGS. 1 and 2, first housing portion 110 includes a first lock 130. First lock 130 is a lever lock that includes a lever secured to the first housing portion 110. As shown in FIG. 1, first lock 130 includes gears 134 (one located on each side of first lock 130) arranged to interface with corresponding gears 114 also secured to first housing 110 that define a range of movement of first lock 130 between an unlocked position as shown in FIG. 3 and a locked position that secures the first and second housing portions 110, 120 in seated alignment, as shown in FIGS. 1 and 4. Gears 114, 134 may also define a range of movement of one or more terminal arrays housed within connector 100 and brought into mating engagement to form a plurality of electrical connections in response to the first lock 130 being moved to the locked position.

FIG. 3 is a diagram showing an example electrical connector with first lock 130 in an unlocked position according to some embodiments. In this position, first lock 130 is in a raised position relative to first housing 110, and second housing portion 120 is arranged in seated alignment with first housing portion 110, unsecured by the first lock 130. First lock 130 may be moved, by a human or machine operator, from the unlocked position to the locked position shown in FIGS. 1 and 4 by moving the lever downward towards first housing portion 110, which causes the lever to interface with the second housing portion 120 to secure the first and second housing portions 110, 120 in seated alignment. For example, moving the first lock 130 to the locked position may secure at least a part of the second housing portion 120 between the lever and the first housing portion 110.

As also shown in FIG. 4, according to some embodiments, second housing portion 120 includes a lever securing feature 128. Feature 128 protrudes from second housing portion 120 in the path of first lock 130 and is configured to act as a spring that depresses in response to a force exerted by the lever and allow the lever to be moved past feature 128 and reach the locked position. In the locked position, as shown in FIG. 4, feature 128 rests above and exerts a downward force upon the lever, thereby preventing first lock 130 from being opened by an operator unless feature 128 is depressed to disengage the lever. In this manner, in the locked position, the first lock 130 interacts with second housing portion 120 to secure the first and second housing portions 110, 120 together in seated alignment.

As also shown in the examples of FIGS. 1, 2, and 5, connector 100 includes a connector position assurance (CPA) device 140 that includes a second lock 150 according to some embodiments. CPA device 140 is configured to interact with first lock 130 and second housing portion 120 to maintain first lock 130 in a locked position, as shown in the example of FIG. 1. The second lock 150 interacts with the first housing portion 110 to further secure the first and second housing portions 110, 120 in seated alignment.

As shown in the example of FIG. 5, CPA device 140 includes a main body 141 which supports a tongue 144, a pair of alignment arms 147, and a second lock 150. As shown in FIGS. 1, 2, and 3, first lock 130 includes a CPA channel 133 sized, shaped, and arranged to receive CPA 140 (i.e., alignment arms 147) in the channel in sliding engagement. Referring to FIG. 3, second housing portion 120 includes a CPA aperture 123 arranged proximal to and underneath lever securing feature 128. Referring to FIGS. 3, 6A-6B, and 7A and 7B, first housing portion 110 presents a ledge 116 configured to interface with second lock 150 of the CPA device 140.

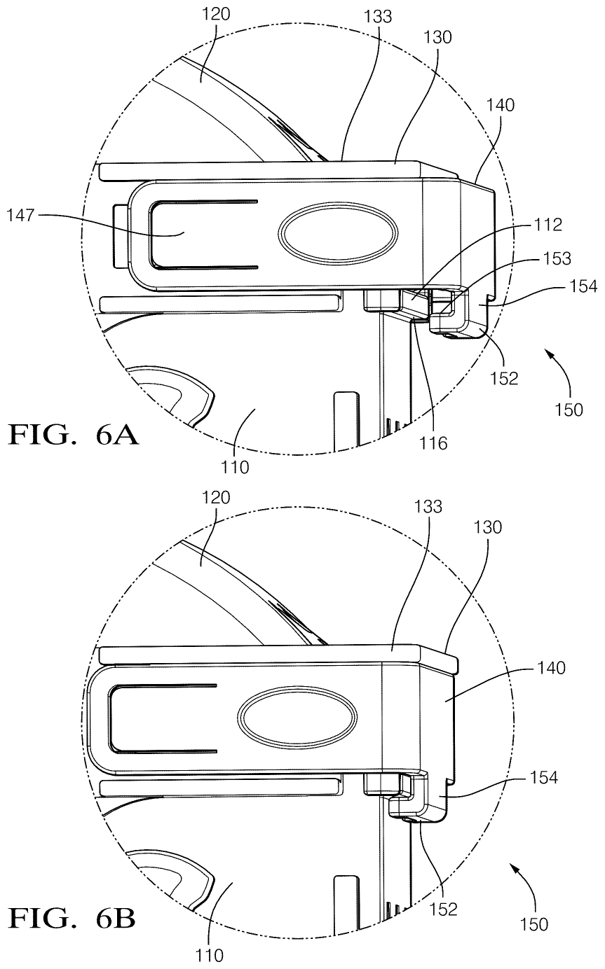

FIG. 6A is a diagram showing CPA device 140 in a pre-staged position in first lock 130, and FIG. 7A is a cross-sectional diagram showing CPA device 140 in the pre-staged position. FIG. 6B is a perspective diagram showing CPA device 140 after it has been moved to a staged position to maintain first lock 130 in the locked position, and FIG. 7B is a cross-sectional diagram showing CPA 140 device after it has been moved to the staged position.

Alignment arms 147 have a size and shape configured to fit within CPA channel 133 and support and align CPA device 140 in the pre-staged position. As shown in FIGS. 6A and 7A, in the pre-staged position, arms 147 are arranged with CPA channel 133, which presents tongue 144 in alignment with CPA aperture 123 and presents second lock 150 in a position to interface with ledge 116 as shown in FIG. 7A.

Alignment arms 147 further define a staged position of the CPA device 140 relative to first lock 130. For example, as shown in the cross-sectional view of FIG. 7B, alignment arms 147 (and corresponding channel 133) may extend to a length sufficient to allow tongue 144 to enter CPA aperture 123 and interface with lever securing feature 128 to prevent it from being depressed, and/or to enable second lock 150 to slidingly engage with ledge 116. In addition, alignment arms 147 may include one or more features 146 (shown in FIG. 5) that “snap” into engagement with one or more corresponding features 136 (as shown in FIGS. 2 and 3) defined in the CPA channel 133 to define a fully staged position of the CPA device 140 and/or to secure a position of CPA device 140 within CPA channel 133.

As shown in FIGS. 7A and 7B, when CPA device 140 is moved by a human or machine operator within CPA channel 133 to the staged position, tongue 144 extends through CPA aperture 123, between first housing 110 and lever securing feature 128. In the staged position, tongue 144 exerts force in opposition to feature 128, preventing feature 128 from being depressed unless CPA device 140 is removed. In addition, as shown in FIG. 7B, when CPA device 140 is moved within CPA channel 133 to the staged position, second lock 150 is brought into sliding engagement with ledge 116, thereby exerting force in opposition to ledge 116 to further secure first and second housing portions 110, 120 in seated alignment.

According to the various embodiments described herein, electrical connector 100 includes first lock 130, which functions to maintain the first and second housing portions 110, 120 in seated alignment, as well as a second lock 150 that further maintains the first and second housing portions 110, 120 in seated alignment. In some examples, the first lock 130 interacts with the second housing portion 120 (e.g., lever securing feature 128) and the second lock 150 interacts with first housing portion 110 (e.g., ledge 116). In some examples, the first lock 130 maintains the first and second housing portions 110, 120 by presenting a force opposed to separation of the first and second housing portions 110, 120, and the second lock 150 presents a further force opposed to separation of the first and second housing portions 110, 120. In this manner, unlike first lock 130 and tongue 144, which both interact with second housing portion 120, second lock 150 interacts with first housing portion 110 (e.g., ledge 116) to further secure the first and second housing portion 110, 120 in seated alignment. As such, second lock 150 serves to further inhibit unintended decoupling of connector 100.

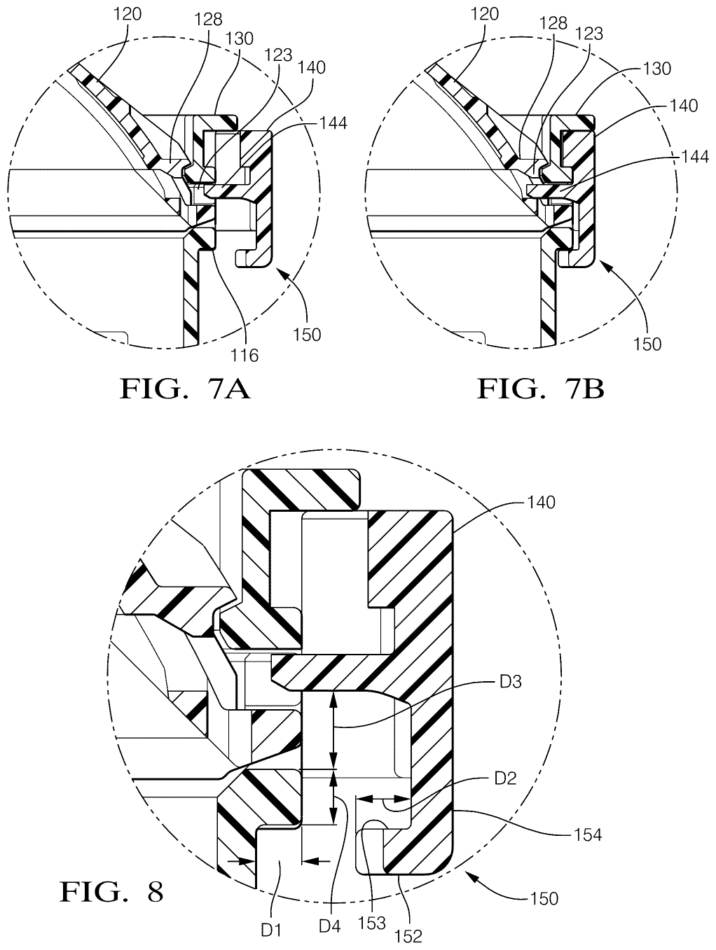

As shown the example of FIG. 5, second lock 150 includes an extender portion 154 and an engagement portion 152 that are sized, shaped, and arranged to slidingly engage with ledge 116. For example, referring now to FIG. 8, which shows CPA 140 in the pre-staged position, ledge 116 may have a width D1, and engagement portion 152 may be formed with a width D2 substantially similar to the width D1. As another example, extender portion 154 may be formed to extend engagement portion 152 to interface with ledge 116 in the staged position. As an example, extender portion 154 may be formed to extend engagement portion 152 to a depth such that engagement portion snugly engages with ledge 116 when CPA 140 is moved within CPA channel 133 from the pre-staged to the staged position. Referring again to FIG. 8, extender portion 154 may have a length substantially equal to a distance between the CPA tongue 144 and ledge 116.

In some examples, referring to the example of FIGS. 1-3, first housing portion 110 includes a lip 112, a surface of which defines ledge 116. According to these examples, a first surface 117 of lip 112 opposes second housing portion 120 (e.g., surface 127) when arranged in seated alignment with first housing portion 110, and a second surface of lip 112 opposed to the first surface 117 defines ledge 116. According to these examples, a length of extender portion 154 may be defined by a distance D3 from the upper surface of the lip 112 to the tongue 144, plus a depth D4 of the lip, as shown in FIG. 8.

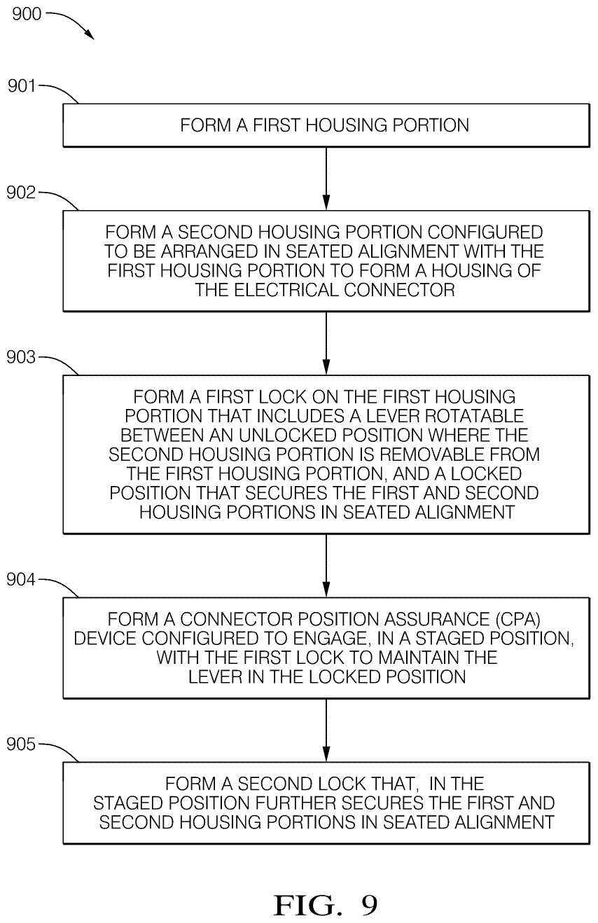

FIG. 9 is a flow diagram depicting one example of a method 900 of providing an electrical connector (e.g., electrical connector 100) according to some embodiments. As shown in FIG. 9, at step 901, the method includes forming a first housing portion (e.g., 110). As also shown in FIG. 9, at step 902, the method includes forming a second housing portion (e.g., 120) that is configured to be arranged in seated alignment with the first housing portion to form a housing of an electrical connector. In some examples, the housing of the electrical connector may house at least one electrical connection formed between electrical conductors as part of an electrical system of a vehicle.

As also shown in FIG. 9, at step 903, the method includes forming a first lock (e.g., first lock 130) on the first housing portion that includes a lever rotatable between an unlocked position where the second housing portion is removable from the first housing portion, and a locked position that secures the first and second housing portions in seated alignment. For example, the first lock 130 may be configured to interface with the second housing portion to secure the first and second housing portions in seated alignment. As an example, the first lock 130 may interface with a lever securing feature (e.g., lever securing feature 128) of the second housing portion to secure the first and second housing portions in seated alignment. For example, moving the lever to the locked position may cause the lever securing feature to depress in response to the lever being moved, and exert a force in opposition to the lever when it reaches the locked position. In some examples, the lever securing feature is arranged to be depressed in order to release the lever from the locked position.

As also shown in FIG. 9, at step 904, the method includes forming a connector position assurance (CPA) device (e.g., CPA device 140) configured to engage, in a staged position, with the first lock to maintain the first lock in the locked position. For example, CPA device 140 may include alignment arms (e.g., alignment arms 147) configured to interface with a channel (e.g., channel 133) presented on the first housing portion, which aligns a tongue (e.g., tongue 144) of the CPA device with a corresponding aperture (e.g., CPA aperture 123) presented on the second housing portion. The CPA aperture 123 may be arranged proximal a lever securing feature (e.g., lever securing feature 128) presented on a second housing portion. When moved to a staged position, the CPA tongue extends into the CPA aperture, exerting an upward force upon the lever securing feature, thereby preventing the first lock from being disengaged. In this manner, the CPA device interacts with the second housing portion to secure the first lock in the locked position.

As also shown in FIG. 9, at step 905, the method includes forming a second lock (e.g., second lock 150) that, in the staged position (e.g., of the CPA device), further secures the first and second housing portions in seated alignment. The second lock may be formed as part of the CPA device. When in a pre-staged position, the second lock presents a surface that slidingly engages with a ledge (e.g., ledge 116) presented by the first housing portion. By engaging with the ledge, the second lock provides an additional force in opposition to unintended separation of the first and second housing portions. In this manner, the second lock further secures the connector housing in seated alignment, in addition to the first lock.

In some examples, the first lock is formed to engage with the second housing portion to secure the first and second housing portions in seated alignment. In some examples, the CPA device is formed to engage with the second housing portion to maintain the first lock in the locked position. In some examples, the second lock is formed to engage with the first housing portion to further secure the first and second housing portions in seated alignment, in addition to the first lock.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An electrical connector, comprising:
a first housing portion configured to receive a second housing portion in seated alignment to form a housing of the electrical connector;
a first lock on the first housing portion that includes a lever rotatable between an unlocked position where the second housing portion is removable from the first housing portion, and a locked position that secures the first and second housing portions in seated alignment;
a connector position assurance (CPA) device that, in a staged position, engages with the first lock to maintain the lever in the locked position; and
a second lock that, in the staged position, further secures the first and second housing portions in seated alignment.

2. The electrical connector of claim 1, wherein the first lock engages the second housing portion to secure the first and second housing portions in seated alignment, and wherein the second lock engages the first housing portion in the staged position to further secure the first and second housing portions in seated alignment.

3. The electrical connector of claim 2, wherein the CPA engages the second housing portion to maintain the lever in the locked position.

4. The electrical connector of claim 2, wherein the second lock engages a ledge of the first housing portion when the CPA is moved from a pre-staged position to the staged position.

5. The electrical connector of claim 4, wherein the second housing portion engages with a first surface of a lip on the first housing portion in the locked position, and wherein the second lock engages with the ledge presented by a second surface of the lip in the staged position.

6. The electrical connector of claim 1, wherein the second lock comprises an extender portion and an engagement portion.

7. The electrical connector of claim 6, wherein the extender portion extends the engagement portion to interface with and oppose a ledge presented by the first housing portion when the CPA is moved from a pre-staged position to a staged position.

8. The electrical connector of claim 7, wherein the CPA engages with the first lock to maintain the lever in the locked position via a tongue that extends through an aperture in the second housing portion when the CPA is moved from a pre-staged position to a staged position; and wherein the extender portion has a length substantially equal to a distance between the tongue and the ledge.

9. A method, comprising:
forming a first housing portion;
forming a second housing portion configured to be arranged in seated alignment with the first housing portion to form a housing of the electrical connector;
forming a first lock on the first housing portion that includes a lever rotatable between an unlocked position where the second housing portion is removable from the first housing portion, and a locked position that secures the first and second housing portions in seated alignment;
forming a connector position assurance (CPA) device configured to engage, in a staged position, with the first lock to maintain the lever in the locked position; and
forming a second lock that, in the staged position further secures the first and second housing portions in seated alignment.

10. The method of claim 9, further comprising:
forming the first lock to interface with the second housing portion in the locked position, and forming the second lock to interface with the first housing portion in the staged position.

11. The method of claim 9, wherein forming the first housing portion comprises forming a ledge on the first housing portion.

12. The method of claim 10, further comprising:
forming the second lock to interface with the ledge.

13. The method of claim 11, wherein forming the CPA further comprises forming a tongue that extends through an aperture in the second housing portion in the staged position; and further comprising:
forming the second lock with a depth substantially equal to a distance between the tongue and the ledge.

14. The method of claim 9, further comprising:
forming the CPA device to interface with the second housing portion to maintain the lever in the locked position.

15. A Connector Position Assurance (CPA) device, comprising:
securing arms arranged to fit within a channel of a first lock of an electrical connector comprising a lever in a pre-staged position of the CPA, and secure the CPA to the lever in a staged position of the CPA;
a tongue feature configured to, in the staged position, maintain the first lock in a locked position to secure a first housing portion and a second housing portion in seated alignment to form a housing of the electrical connector; and
a second lock that further secures the first and second housing portions in seated alignment.

16. The CPA of claim 15, wherein the securing feature further comprises:
snap features presented on the pair of arms configured to interface with corresponding snap features presented on the lever to define the staged position and/or secure the CPA in the staged position.

17. The CPA of claim 15, wherein the second lock interfaces with a first housing portion of the electrical connector to maintain the first lock in the locked position, and the first lock interfaces with a second housing portion in the locked position.

18. The CPA of claim 15, wherein the second lock is configured to interface with a ledge presented by the first housing portion in the staged position.

19. The CPA of claim 15, wherein the second lock includes an extender portion and an engagement portion.

20. The CPA of claim 16, wherein the extender portion extends the engagement portion to interface with a ledge of the first housing portion in the staged position.
